(19) United States
(12) Patent Application Publication
(10) Pub. No.: US 2016/0361733 A1
(43) Pub. Date: Dec. 15, 2016

(54) SPRAY GUN

(71) Applicant: WALMEC S.p.A., SANTA LUCIA DI PIAVE (IT)

(72) Inventor: Paolo ZANETTI, SANTA LUCIA DI PIAVE (IT)

(21) Appl. No.: 15/177,355

(22) Filed: Jun. 9, 2016

(30) Foreign Application Priority Data
Jun. 11, 2015 (IT) 102015000022640

(51) Int. Cl. B05B 12/00; B28B 1/00; B28B 19/00; B05B 7/08; B29C 45/14

(52) U.S. Cl. CPC B05B 12/002; B05B 7/0815; B29C 45/1418; B28B 19/00; B28B 1/002; B28B 1/008; B29K 2705/02

(57) ABSTRACT

A spray gun for spraying and a method for producing it are described. The problem is solved of reducing the weight thereof and increase the mechanical resistance by producing it with a body (12), a nozzle (18) that can be fed through a duct internal to the body and is able to spray the product, and a jacket (50) superimposed on the body.

### FIELD OF THE INVENTION

The present invention relates to a spray gun for spraying and a method for producing it.

### BACKGROUND OF THE INVENTION

Spray guns, see e.g. the type described in EP2803421, usually have a graspable body provided with a nozzle capable of spraying a coating product (e.g. paint) and air. The nozzle is formed in a cap screwable on the body, which also comprises various threaded fittings to which the tubes carrying the sprayable product and the air are to be connected. The tubes (or relevant fittings thereof) are mounted on threaded bushings of the spray gun, which communicate with internal ducts inside the body that lead up to the nozzle. Often the graspable body has the shape of a gun with a trigger to control the jet, for greater comfort of use.

The problem of comfort for a spray gun is very important but still partially unsolved. A body shop repairman, for example, holds it all day, therefore good ergonomics and low weight are essential factors to allow the user a high and prolonged quality in the spraying work. A weary hand—as everyone knows—loses precision and makes mistakes. On the other hand, the pressures and efforts at play, as well as the threaded fittings for connecting the tubes, dictate for the structure of the spray gun minimum safety thicknesses, which clash with the desire to decrease its weight. If too small a thickness is used for the threaded bushings, they will sooner or later give way and the spray gun must be disposed.

The main object of the invention is to provide an improved spray gun which solves at least one of the above problems.

Another object is to provide a lighter and/or more resistant spray gun.

At least one object is achieved with a spray gun and method as defined in the independent Claims.

### BRIEF SUMMARY OF THE INVENTION

A first aspect of the invention relates to a spray gun for spraying a product, comprising:
a metallic body connectable to a grip or handle,
a nozzle that can be fed through a duct internal to the body and is able to spray the product,
a jacket made of rigid material superimposed on the metallic material of the body, wherein (the layer of) the jacket boosts the mechanical resistance of the body, which remains light nevertheless.

The jacket has several advantages, including:
it allows to reduce the volume of the metallic component of the body, thereby reducing its weight;
it strengthens the openings of the body, especially the threads or the threaded bushing, by surrounding the perimeter thereof.

The jacket may be done in various ways, e.g. through over-injection or pouring of material, or by mechanical shape-coupling (e.g. through snap-coupling or adhesives).

The jacket may be made out of sundry materials, preferably a thermoplastic material, optionally added with a dispersion of mineral fillers, that is over-molded to the metallic body.

The thermoplastic material may comprise or be constituted by e.g. resin, PPS or polyamide.

The mineral filler may comprise or preferably be constituted by fibers, in particular carbon fibers or glass fibers.

Preferably the jacket uniformly covers the entire body surrounding the openings of its internal ducts.

In particular, in the spray gun the body may comprise a threaded bushing, which is connectable to a tube for feeding the nozzle through the inner duct, and the jacket may be placed in correspondence of and/or around the bushing. This improves the resistance of the threads, the part mostly under mechanical stress. The jacket may be placed all around, the perimeter of the bushing, for maximum strength.

Preferably, the jacket comprises a layer of carbon which in turn comprises a layer of pre-impregnated carbon fibers, and/or the jacket has a thickness of 0.5 mm to 2 mm, preferably 1 mm. This ensures resistance as well as minimum final weight.

The spray gun may comprise a cap or ring which is fixable at the outlet of the internal duct and is provided with a hole constituting the nozzle, and/or the body is e.g. an aluminum block. Preferably the cap or ring is made from carbon fibers.

A second aspect of the invention relates to a method for producing the central metallic body of a spray gun for spraying a product, the body comprising a duct internal to the body, having an inlet and an outlet on the body, adapted to supply a spraying nozzle with the product, comprising the steps of:
forging a metal block with the dimensional features of the central body, the block comprising a threaded bushing;
applying on the body's surface a jacket which covers it surrounding said inlet, said outlet and the bushing.

The effects of the method are similar to those described for the spray gun, and in the method the jacket benefits from the same variants as described before for the spray gun According to the material chosen for the jacket, the method may have several variations. E.g. if the jacket is a carbon layer, the method has the following additional steps:
arranging in a mold a sheet or layer of carbon fiber, preferably two sheets or layers, one for each side of the block;
placing the block into the mold and between the two said sheets or layers, or in contact with a said sheet or layer;
closing the mold and heating the mold to harden the layer(s) or sheet(s);
removing from the mold the assembly thus obtained.

If the jacket instead is a thermoplastic material over-molded on the body, the method may have the following additional steps:
arranging the block in a mold;
closing the mold and injecting the thermoplastic material in the mold to carry out the jacket superimposed on the body;
removing the assembly thus obtained from the mold.

Preferably, after forging the block is milled to derive or to refine the threaded bushing, so as to increase the machining accuracy.

In particular, it is advantageous to process the assembly consisting of the block and the superimposed jacket, wherein the processing consists e.g. of milling the threads on the body, or the elimination of burrs, or the finishing of contours, especially in correspondence of said bushing or said inlet and outlet. In this way the mechanical machining, preferably by numerical control machines (CNC), can act simultaneously on the metal body and on the material of the jacket, thus greatly increasing the processing accuracy and decreasing the production defects.

In general the number of threaded bushings in the body depends on the application.

### BRIEF DESCRIPTION OF THE SEVERAL VIEWS OF THE DRAWINGS

The present invention will hereinafter be further described in preferred embodiments, with reference to the accompanying drawings wherein:

FIG. 1 shows a three dimensional view of a spray gun;

FIG. 2 shows a side view of a body comprised in the spray gun of FIG. 1;

FIG. 3 shows a sectional view of the body of FIG. 2.

### DETAILED DESCRIPTION OF THE INVENTION

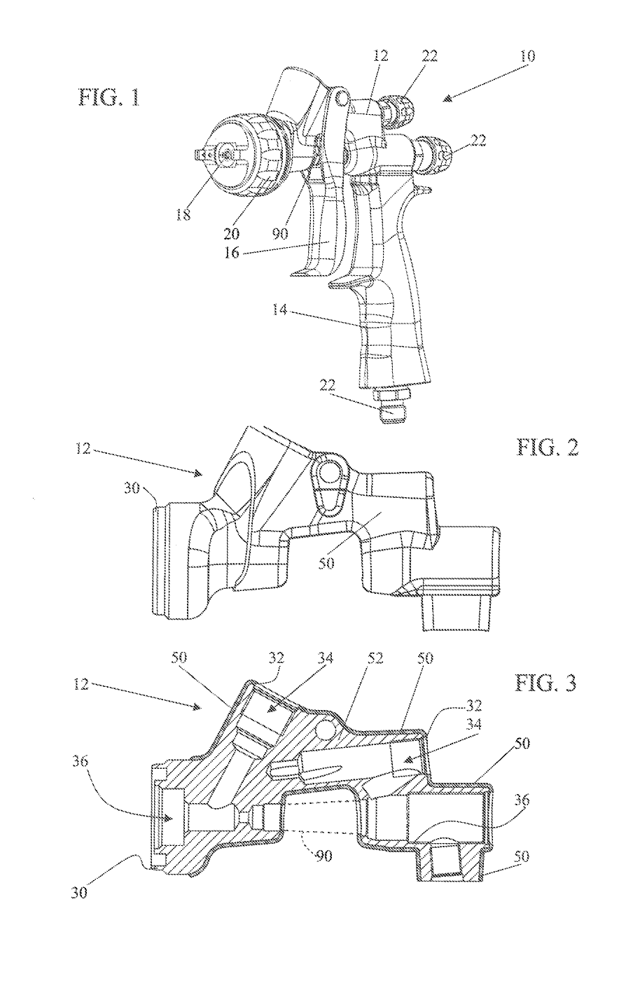

A spray gun 10 (FIG. 1) comprises a central body 12 coupled at one end to a handle or grip 14 and at the other to a ring or cylindrical cap 20 provided with a hole or nozzle 18. The cap or ring 20 can be screwed on a front thread 30 (FIG. 2) of the body 12, to which is also hinged a lever or trigger 16, with the function of controlling the spraying jet outgoing from the nozzle 18.

The body 12 (FIG. 3) comprises circular openings 34, provided with a perimetral thread 32, to which are screwable some fittings 22 adapted for connecting with tubes (not shown) that lead compressed air and/or the product to be sprayed to the spray gun. FIG. 3 shows internal ducts 3 of known type, of the body 12 which serve to convey towards an opening 36 for the nozzle 18 the material incoming from the fittings 22. The flow of material or product is controllable by a valve 50 controlled by the trigger 16.

In particular, from FIG. 3, the layered structure of the body 12 can be appreciated. It comprises a metal inner block 52, e.g. made of aluminum (which is easily workable), coated with a layer or jacket 50 made out carbon fibers or thermoplastic material; in particular the layer 50 is present around the threads 32 or the metal crowns that form them. The carbon e.g. is about 10 times harder than aluminum, thus the strength of the threads 32 is highly enhanced. Note indeed that the threads 32 are usually formed in the portions of the block 52 which have quite limited thickness, therefore without the layer or jacket 50 the structural strength is not satisfactory.

The layer or jacket 50 being lightweight, the weight of the spary gun is not affected; rather, the strength being equal, the block 52 can be produced with less metal, and thus the overall weight can be considerably reduced. The layer or jacket 50 may have e.g. a thickness of 0.5 mm to 2 mm, preferably 1 mm.

A method for producing the assembly piece of FIGS. 2 and 3 may have the following steps:
taking a metal block forged with the dimensional features of the block 52;
optionally the forged block is milled to remove excess metal portions, to lighten or shape some parts thereof;
optionally the block is milled to derive the threads 32;
in a mold, a sheet or layer of carbon fiber is arranged, preferably two sheets or layers, one on each side of the forged block;
the forged block is arranged inside the mold and between the two said sheets or layers, or in contact with a said sheet or layer;
the mold is closed and heated to harden the layer or sheet;
the assembly thus obtained is removed from the mold, preferably processing it thereafter to remove burrs or excesses of a sheet or layer.

The final surface of the layer or jacket 50 is smooth and shiny, so that it also favors the handling and cleaning.

Preferably, the layer or jacket 50 comprises or is constituted solely by one or more (known) sheets of PRE-PREG, or pre-impregnated carbon fibers. Said PRE-PREG is e.g. a fabric composed of carbon fibers, glass fibers or Kevlar fibers, generally pre-impregnated with a resin, e.g. an epoxy-based resin.

Another method to produce the assembly piece of FIGS. 2 and 3 may have the following steps:
taking a metal block forged with the dimensional features of the block 52;
arranging the forged block into a mold, and thermoplastic material is injected into the mold to produce the layer or jacket 50;
the assembly thus obtained is removed from the mold;
the assembly of the body and the jacket is processed to remove burrs or excess material, wherein during the processing, which preferably takes place with numerical control machines, in particular:
the forged block is milled to remove excess portions of metal, to lighten or shape some parts thereof; and/or
the block is milled to obtain the threads 32; and/or
the block is milled to obtain the thread 30; and/or the circular openings 34 are refined; and/or
the inner conduits 36 of the body 12 are refined.

The peculiarity of processing or finishing the assembly formed by the body and jacket allows not only increasing the processing precision of the assembly, but also correcting possible defects of the jacket.

Note that another advantage of the jacket 50 is to foster the cleaning and good maintenance of the spray gun 10. The residues of sprayed paint or product falling on the metallic body of the prior art tend to tenaciously adhere thereto as on the surface of the sprayed object (think of a car body); however if they end up on the jacket 50 they are easier to remove.

The trigger or lever 16 may be advantageously an element produced from a (e.g. folded) sheet of carbon. It thus results very light and durable. The cap or ring 20 may advantageously be an element made out of carbon fibers, to be very light and durable.

1. Spray gun for spraying a product, comprising:
a metallic body connectable to a grip or handle,
a nozzle that can be fed through a duct internal to the body and is able to spray the product,
a jacket made of rigid material superimposed on the metallic material of the body.

2. Spray gun according to claim 1, wherein the body comprises a threaded bushing, which is connectable to a tube for feeding the nozzle through the internal duct, and the jacket is placed in correspondence of and around the bushing.

3. Spray gun according to claim 2, wherein the jacket is placed all around the perimeter of the bushing.

4. Spray gun according to claim 1, comprising a cap or ring which is fixable at the outlet of the internal duct and is provided with a hole constituting the nozzle.

5. Spray gun according to claim 1, wherein the jacket comprises or is constituted by a resin, PPS or polyamide or a carbon layer.

6. Spray gun according to claim 1, wherein the jacket comprises a dispersion of mineral fillers, like e.g. glass or carbon fibers.

7. Spray gun according to claim 1, wherein the jacket comprises a layer of pre-preg carbon fibers.

8. Spray gun according to claim 1, wherein the body is an aluminum block.

9. Spray gun according to claim 1, wherein the jacket has a thickness of 0.5 mm to 2 mm, preferably 1 mm.

10. Spray gun according to claim 4, wherein the cap or ring is made from carbon fibers.

11. Method for producing the central body of a spray gun for spraying a product, the body comprising a duct internal to the body adapted to supply a spray nozzle with the product, comprising the steps of:
forging a metal block with the dimensional features of the central body, the block comprising a threaded bush;
applying on the body's surface a jacket which covers it surrounding said inlet, said outlet and the bushing.

12. Method according to claim 11, with the further steps of:
arranging in a mold a sheet or layer of carbon fiber, preferably two sheets or layers, one for each side of the block;
placing the block into the mold and between the two said sheets or layers, or in contact with a said sheet or layer;
closing the mold and heating the mold to harden the layer(s) or sheet(s);
removing from the mold the assembly thus obtained.

13. Method according to claim 11, with the further steps of:
arranging the block in a mold;
closing the mold and injecting the thermoplastic material in the mold to carry out the jacket superimposed on the body;
removing the assembly thus obtained from the mold.

14. Method according to claim 11, wherein the assembly consisting of the block and the superimposed jacket is processed, wherein the processing consists e.g. of milling the threads on the body, or the elimination of burrs, or the finishing of contours, especially in correspondence of said bushing or said inlet and outlet.

15. Method according to claim 11, wherein after forging the block is milled to create the threaded bushing.
